(19) United States
(12) Patent Application Publication
(10) Pub. No.: US 2015/0268917 A1
(43) Pub. Date: Sep. 24, 2015

(54) APPARATUS, METHOD, AND COMPUTER PROGRAM PRODUCT FOR ALIGNING IMAGES VIEWED ACROSS MULTIPLE DISPLAYS

(71) Applicant: Nokia Technologies Oy, Espoo (FI)

(72) Inventors: Jussi Artturi Leppanen, Tampere (FI); Arto Juhani Lehtiniemi, Lempaala (FI); Antti Johannes Eronen, Tampere (FI); Miikka Vilermo, Siuro (FI)

(21) Appl. No.: 14/220,739

(22) Filed: Mar. 20, 2014

(51) Int. Cl. G06F 3/14

(52) U.S. Cl. CPC G06F 3/1446

(57) ABSTRACT

Mechanisms are described for sensing and compensating for the misalignment of multiple displays that are cooperating to present an image. A unitary viewing area is determined across the multiple displays that includes a portion of the first display and a portion of the second display based on a location of a linear component of a single user input applied to both displays, such as a hovering gesture provided by a user's finger. The unitary viewing area is determined in such a way that the portion of the image presented on the first display is horizontally aligned with the portion of the image presented on the second display within the viewing area. In this way, the image appears continuous to the viewer across the displays, regardless of the misalignment of the user devices.

### TECHNOLOGICAL FIELD

Example embodiments of the present invention relate generally to mechanisms for achieving and maintaining proper presentation of images on one or more displays.

### BACKGROUND

With the proliferation of mobile devices, users have the ability to access and view digital images in various situations. From still pictures to videos, users have an increasing need and desire to view images on their mobile device displays and to share such viewing experiences with others.

### BRIEF SUMMARY OF EXAMPLE EMBODIMENTS

Accordingly, it may be desirable to provide tools that allow users to easily and effectively view images using multiple mobile device displays. In this regard, embodiments of the invention described herein provide mechanisms for displaying images across multiple user device displays, even in situations in which the displays are not aligned. Rather, the mechanisms described herein are configured to determine a relative horizontal alignment between two or more mobile device displays and to determine an optimal presentation of an image across the multiple displays.

In some embodiments, an apparatus is provided that comprises at least one a processor and at least one memory including computer program code. The at least one memory and the computer program code may be configured to, with the at least one processor, cause the apparatus at least to receive an indication that at least a first display of a first user device and a second display of a second user device are to cooperatively present an image and to receive an indication of a user input. The user input may be a single user input that is applied to each of the first user device and the second user device substantially simultaneously and may comprise a linear component spanning the first and second displays. A unitary viewing area may be determined that comprises a portion of the first display and a portion of the second display based on a location of the linear component with respect to the first display and the location of the linear component with respect to the second display. Moreover, the image may be caused to be presented in the unitary viewing area such that an adjoining edge of a first portion of the image presented on the first display is substantially aligned with an adjoining edge of a second portion of the image presented on the second display, with the first and second portions of the image being continuous across the first and second displays. The single user input may comprise a hovering gesture provided above both the first and second displays.

In some cases, the at least one memory and the computer program code may be further configured to, with the at least one processor, cause the apparatus to detect a change in a vertical position of one of the first or second user devices and adjust a configuration of the unitary viewing area in response to the change detected. Additionally or alternatively, the at least one memory and the computer program code may be further configured to, with the at least one processor, cause the apparatus to receive an indication of a confirming input applied to one of the first or second displays, wherein receipt of the indication of the confirming input triggers the determination of the unitary viewing area.

In some embodiments, the at least one memory and the computer program code may be further configured to, with the at least one processor, cause the apparatus to determine the unitary viewing area by calculating a first distance between the linear component and a top or bottom edge of the first display, calculating a second distance between the linear component and a corresponding top or bottom edge of the second display, and calculating a difference between the first distance and the second distance. The at least one memory and the computer program code may be further configured to, with the at least one processor, cause the apparatus to receive an indication that at least a third display of a third user device is to cooperatively present the image with the first display and the second display. Moreover, the at least one memory and the computer program code may be further configured to, with the at least one processor, cause the apparatus to cause the image to be presented in the unitary viewing area by scaling the image to fit within the unitary viewing area. In some cases, the at least one memory and the computer program code may be further configured to, with the at least one processor, cause the apparatus to cause the image to be presented in the unitary viewing area by causing a portion of the image corresponding to a size of the unitary viewing area to be presented in the unitary viewing area.

In some embodiments, the at least one memory and the computer program code may be further configured to, with the at least one processor, cause the apparatus to receive an indication that at least a third display of a third user device is to cooperatively present the image with the first display and the second display; designate one of the first, second, or third user devices as a master device; and cause the portion of the image presented to be shifted within the unitary viewing area based on a detected change in a location of the master device with respect to the other devices.

In embodiments in which the image presented in the unitary viewing area is smaller than the unitary viewing area, the at least one memory and the computer program code may be further configured to, with the at least one processor, cause the apparatus to present at least one additional image with the image presented within the unitary display.

In other embodiments, a method and a computer program product are described that receive an indication that at least a first display of a first user device and a second display of a second user device are to cooperatively present an image; receive an indication of a user input, where the user input is a single user input that is applied to each of the first user device and the second user device substantially simultaneously and comprises a linear component spanning the first and second displays; determine a unitary viewing area comprising a portion of the first display and a portion of the second display based on a location of the linear component with respect to the first display and the location of the linear component with respect to the second display; and cause the image to be presented in the unitary viewing area such that an adjoining edge of a first portion of the image presented on the first display is substantially aligned with an adjoining edge of a second portion of the image presented on the second display, where the first and second portions of the image are continuous across the first and second displays.

In some cases, the method and computer program product may further include detecting a change in a vertical position of one of the first or second user devices and adjusting a configuration of the unitary viewing area in response to the change detected. Moreover, an indication of a confirming input applied to one of the first or second displays may be received, wherein receipt of the indication of the confirming input triggers the determination of the unitary viewing area.

In some embodiments, the image may be caused to be presented in the unitary viewing area by causing a portion of the image corresponding to a size of the unitary viewing area to be presented in the unitary viewing area. In such cases, an indication that at least a third display of a third user device is to cooperatively present the image with the first display and the second display may be received, and one of the first, second, or third user devices may be designated as a master device. The portion of the image presented may be caused to be shifted within the unitary viewing area based on a detected change in a location of the master device with respect to the other devices.

In still other embodiments, an apparatus is provided for presenting a portion of an aligned image for viewing by a user. The apparatus may include means for receiving an indication that at least a first display of a first user device and a second display of a second user device are to cooperatively present an image; means for receiving an indication of a user input, where the user input is a single user input that is applied to each of the first user device and the second user device substantially simultaneously and comprises a linear component spanning the first and second displays; means for determining a unitary viewing area comprising a portion of the first display and a portion of the second display based on a location of the linear component with respect to the first display and the location of the linear component with respect to the second display; and means for causing the image to be presented in the unitary viewing area such that an adjoining edge of a first portion of the image presented on the first display is substantially aligned with an adjoining edge of a second portion of the image presented on the second display, where the first and second portions of the image are continuous across the first and second displays.

### BRIEF DESCRIPTION OF THE SEVERAL VIEWS OF THE DRAWING(S)

Having thus described example embodiments of the invention in general terms, reference will now be made to the accompanying example drawings, which are not necessarily drawn to scale, and wherein:

FIG. 1 shows two user devices cooperating to present an image across the displays of both user devices, where the user devices are aligned;

FIG. 2 shows two conventional user devices cooperating to present an image across the displays of both user devices, where the user devices are misaligned;

FIG. 3 illustrates a schematic block diagram of a user device for presenting a portion of an aligned image for viewing by a user according to an example embodiment of the present invention;

FIG. 4 illustrates a schematic block diagram of an apparatus for determining a unitary viewing area for the presentation of an image across multiple displays, where the image portions presented on each display are substantially aligned with each other according to an example embodiment of the present invention;

FIG. 5 illustrates two user devices that are cooperating to present an image and the provision of a single user input for aligning the image portions to be presented according to an example embodiment of the present invention;

FIG. 6 illustrates a unitary viewing area that is determined across the displays of the user devices of FIG. 5 according to an example embodiment of the present invention;

FIG. 7 illustrates a calculation of distances between a top edge of each user device display and the respective location of a linear component of the single user input for determining the unitary viewing area according to an example embodiment of the present invention;

FIGS. 8A-8C illustrate different configurations of unitary viewing areas determined across two user device displays having different amounts of misalignment according to an example embodiment of the present invention;

FIG. 9 illustrates the presentation of a cropped portion of an image in the unitary viewing area according to an example embodiment of the present invention;

FIG. 10 illustrates three user devices that are cooperating to present an image across the displays of the three user devices according to an example embodiment of the present invention;

FIG. 11A illustrates multiple user devices that are cooperating to present an image across the multiple displays, where the image presented is a portion of the whole image according to an example embodiment of the present invention;

FIG. 11B illustrates a shifting of the portion of the image presented based on the detected motion of one of the user devices that is designated as a master user device according to an example embodiment of the present invention according to an example embodiment of the present invention;

FIG. 12 illustrates the presentation of additional images alongside the original image to be presented within a unitary viewing area presented across multiple displays according to an example embodiment of the present invention;

FIG. 13 illustrates a unitary viewing area that is determined across the displays of the user devices having different sizes of displays according to an example embodiment of the present invention; and

FIG. 14 illustrates a flowchart of methods of determining a unitary viewing area for presenting an image across multiple displays, where the image portions are substantially aligned with each other according to an example embodiment of the present invention.

### DETAILED DESCRIPTION

Some example embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

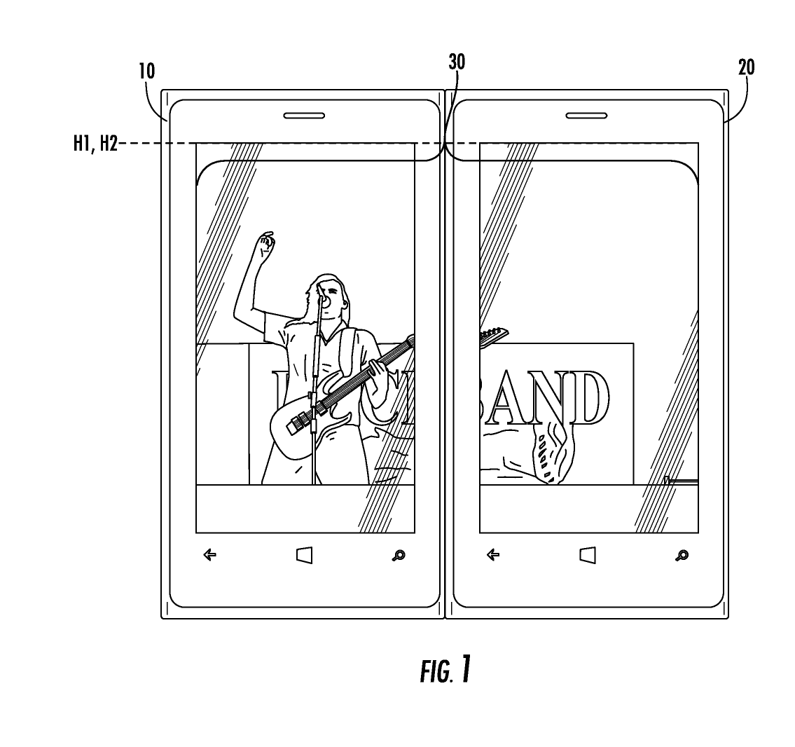

As devices for capturing images, such as smartphones with built-in cameras and video recorders, become more prevalent, users are capturing more images and are accessing previously stored images for viewing more often. Frequently, users have a desire to share their captured images with other users around them. With some conventional devices, two users each having his or her own user device 10, 20 may be able to view the same image 30 displayed across both user device displays, as shown in FIG. 1. Half of the image would be presented on one user device 10, with the other half being presented on the other user device 20. As long as the two devices 10, 20 are horizontally aligned (e.g., as indicated by the alignment of the top edges of the displays H1, H2), the two halves of the image 30 are also aligned and provide a pleasant viewing experience to the users, as shown in FIG. 1.

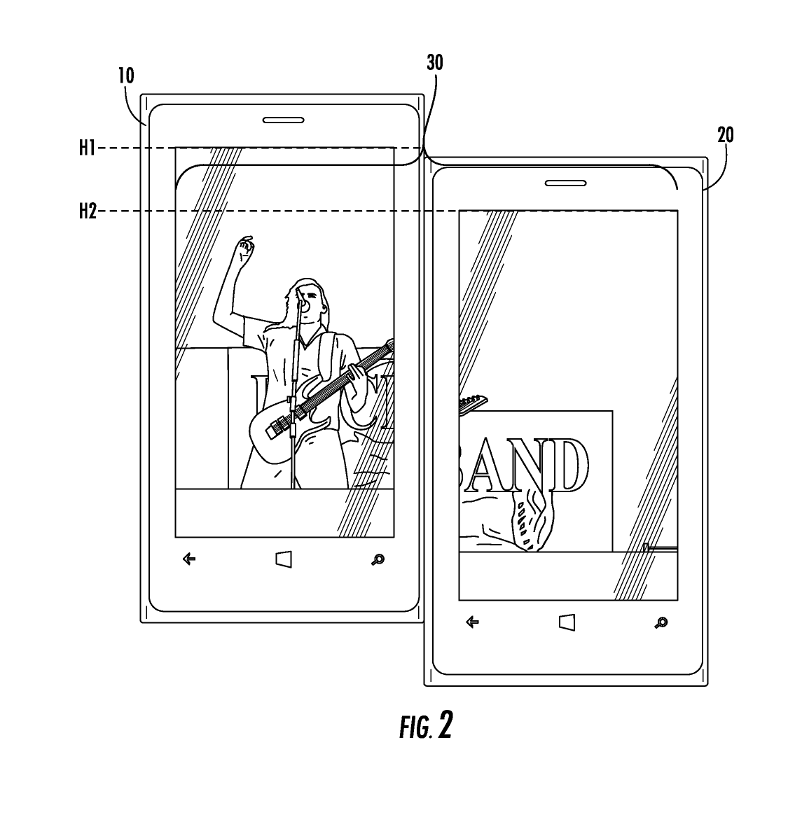

According to prior art solutions, however, if the two devices 10, 20 come out of alignment, as shown in FIG. 2 with reference to the spacing between the respective top edges of the displays H1, H2, the image portions are no longer horizontally aligned, creating a disjointed viewing experience. Thus, if each user is holding his or her own device 10, 20 next to the other user's device 10, 20, it is generally difficult, if not impossible, to achieve and/or maintain proper alignment of the image portions so as to produce the same or similar viewing experience that the users would get viewing the image on a single user device.

Accordingly, example embodiments of the present invention provide mechanisms for sensing and compensating for misalignment of the displays presenting the image, such that image portions presented on two different, misaligned displays are adjusted to provide aligned image portions to create a continuous image across the displays.

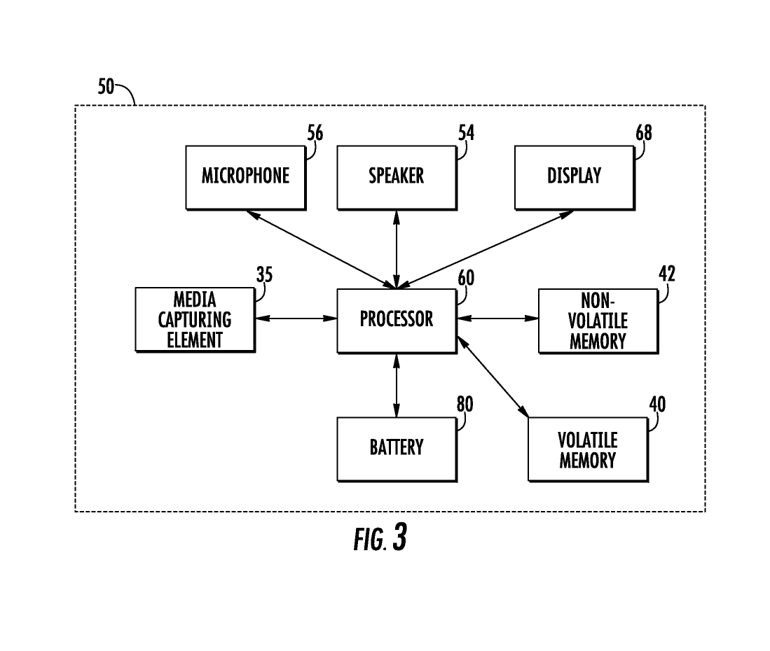

Turning now to FIG. 3, which provides one example embodiment, a block diagram of a user device 50 that would benefit from embodiments of the present invention is illustrated. The user device 50 may be any device that is, includes, or is in communication with a camera or other media capturing element 35 or that is otherwise configured to allow previously-captured still images or video to be viewed, such as on a display 68 of the user device 50. It should be understood, however, that the user device 50 as illustrated and hereinafter described is merely illustrative of one type of device that may benefit from embodiments of the present invention and, therefore, should not be taken to limit the scope of embodiments of the present invention. For example, in some embodiments the user device 50 may be a personal digital assistant (PDA), smartphone, pager, mobile television, gaming device, laptop computer, tablet computer, touch surface, wearable device, or any combination of the aforementioned, and other types of voice and text communications systems.

Referring again to FIG. 3, the user device 50 may include a processor 60 or other processing device, which controls the functions of one or more components of the user device 50. In some embodiments, the processor 60 may include circuitry desirable for implementing audio and logic functions of the user device 50. For example, the processor 60 may be comprised of a digital signal processor device, a microprocessor device, and various analog to digital converters, digital to analog converters, and other support circuits. Control and signal processing functions of the user device 50 are allocated between these devices according to their respective capabilities. The processor 60 may include functionality to operate one or more software programs, which may be stored in memory.

The user device 50 may also comprise a user interface including an output device such as a conventional earphone or speaker 54, a microphone 56, a display 68, and a user input interface, all of which are coupled to the processor 60. The user input interface, which allows the user device 50 to receive data, may include any of a number of devices allowing the user device 50 to receive data, such as a keypad, a touch screen display (display 68 providing an example of such a touch screen display), or other input device. In embodiments including a keypad, the keypad may include the conventional numeric (0-9) and related keys (#, *), and other hard and soft keys used for operating the user device 50. Alternatively or additionally, the keypad may include a conventional QWERTY keypad arrangement. The keypad may also include various soft keys with associated functions. In addition, or alternatively, the user device 50 may include an interface device such as a joystick or other user input interface. The user device 50 may further include a battery 80, such as a vibrating battery pack, for powering various circuits that are required to operate the user device 50.

The user device 50 may further include volatile memory 40, such as volatile Random Access Memory (RAM) including a cache area for the temporary storage of data. The user device 50 may also include other non-volatile memory 42, which may be embedded and/or may be removable. The memories may store any of a number of pieces of information, and data, used by the user device 50 to implement the functions of the user device 50. Moreover, the memories may store one or more captured images, including still images and video recordings that are captured by the user device 50 or devices (e.g., a camera) accessible to the user device.

It should also be noted that while FIG. 3 illustrates one example of a configuration of a user device 50 configured to present a portion of an aligned image presented across multiple displays, numerous other configurations may also be used to implement embodiments of the present invention. As such, in some embodiments, although devices or elements are shown as being in communication with each other, hereinafter such devices or elements should be considered to be capable of being embodied within a same device or element and, thus, devices or elements shown in communication should be understood to alternatively be portions of the same device or element.

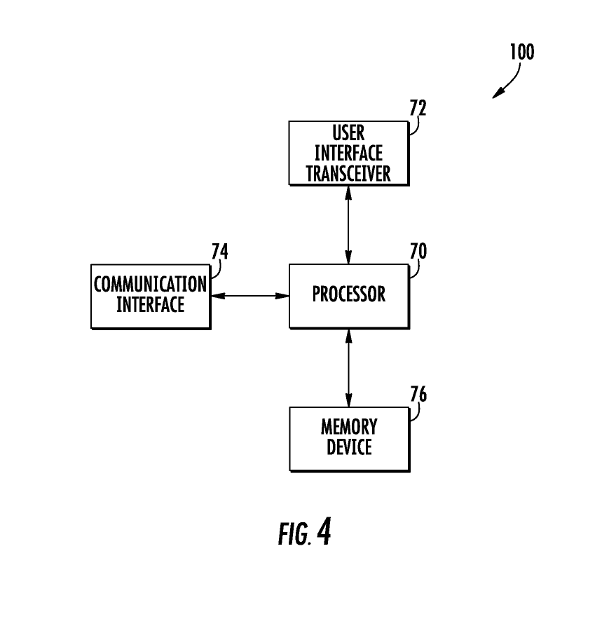

With reference to FIG. 4, an apparatus 100 for causing presentation of an aligned image across multiple displays is shown. The apparatus 100 may, in some embodiments, be embodied by the user device 50 of FIG. 3. The apparatus 100 may include or otherwise be in communication with a processor 70 (such as the processor 60 of the user device 50 of FIG. 3), a user interface transceiver 72, a communication interface 74, and a memory device 76. In some embodiments, the processor 70 (and/or co-processors or any other processing circuitry assisting or otherwise associated with the processor 70) may be in communication with the memory device 76 via a bus for passing information among components of the apparatus 100. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, content, applications, instructions, or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70, as well as images (e.g., still and video images) captured by an image capturing device and/or alterations or modifications to the presentation of the images determined by the apparatus 100 according to embodiments of the invention described herein and/or provided by the user.

The apparatus 100 may, in some embodiments, be a user device 50 (such as the user device of FIG. 3) with image capturing capability (e.g., a smartphone), an image capturing device, or a fixed communication device or computing device configured to employ an example embodiment of the present invention. However, in some embodiments, the apparatus 100 may be embodied as a chip or chip set. In other words, the apparatus 100 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 100 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard-coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 100. In this regard, the communication interface 74 may include, for example, an antenna (or multiple antennas) and supporting hardware and/or software for enabling communications with a wireless communication network. Additionally or alternatively, the communication interface 74 may include the circuitry for interacting with the antenna(s) to cause transmission of signals via the antenna(s) or to handle receipt of signals received via the antenna(s). In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface transceiver 72 may be in communication with the processor 70 to receive an indication of a user input and/or to cause provision of an audible, visual, mechanical or other output to the user. As such, the user interface transceiver 72 may include, for example, a keyboard, a mouse, a joystick, a display, a touch screen(s), touch areas, soft keys, a microphone, a speaker, or other input/output mechanisms. For example, the user interface transceiver 72 may include or be in communication with a touch screen display (such as the touch screen display 68 of FIG. 3) that is configured to present images, such as previously captured still pictures and video images, for viewing by the user. In different example cases, the touch screen display 68 may be a two dimensional (2D) or three dimensional (3D) display. The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, and/or other techniques. The user interface transceiver 72 may be in communication with the touch screen display 68 to receive indications of user inputs at the touch screen display 68 and to modify a response to such indications based on corresponding user actions that may be inferred or otherwise determined responsive to the indications.

In this regard, various indications of user input may be received as a result of touch or proximity events at the touch screen display 68. For example, with respect to a touch event, a force indication may be received, which is indicative of the amount of force applied due to contact with the touch screen display 68. Alternatively or additionally, a position indication may be received (e.g., x-, y-coordinates) that describes the location of the contact. As another example, a proximity indication may be received in some cases that is indicative of the proximity of an object (such as the user's finger or some other object) to the touch screen display 68. For example, in some embodiments described herein, the user may provide a hovering gesture as an input by holding his or her finger in proximity to the touch screen display 68 for a predefined period of time.

Alternatively or additionally, the processor 70 may comprise user interface circuitry configured to control at least some functions of one or more user interface elements such as, for example, a speaker, microphone, display, and/or the like. The processor 70 and/or user interface circuitry comprising the processor 70 may be configured to control one or more functions of one or more user interface elements through computer program instructions (e.g., software and/or firmware) stored on a memory accessible to the processor 70 (e.g., memory device 76, and/or the like).

Embodiments of the invention will now be described with reference to the figures. As noted above, conventional user devices 10, 20, as shown in FIGS. 1 and 2, may be configured to cooperate with each other to present an image across the displays of both user devices. For example, User A may be viewing an image on his user device 10 and may want to share the viewing experience with another user, User B, who has her own user device 20. With some conventional devices, User B may “tap” her device 20 with User A's device 10, and the bringing together of the two devices may result in the image 30 that was formerly presented only on the display of User A's device 10 to be presented as a larger image across both displays, as shown in FIG. 1. Thus, half of the image 30 may be presented on User A's device 10, and the other half of the image may be presented on User B's device 20.

If the two devices 10, 20 are horizontally aligned, such that the top edges of the displays H1, H2 are aligned, for example, the two halves of the image 30 may also be aligned, providing a proper presentation of the full image to the users, as shown in FIG. 1. According to prior art solutions, however, if the two devices 10, 20 come out of alignment, as shown in FIG. 2, the two halves of the image 30 would no longer be horizontally aligned, resulting in a disjointed presentation of the image.

Accordingly, embodiments of the present invention provide mechanisms for automatically adjusting the presentation of portions of an image across multiple displays, such that any misalignment of the displays is compensated for through presentation of the image portions. In this way, alignment of the image portions across the multiple displays is independent of the alignment of the displays themselves, and the users may be able to view a continuous and accurate representation of the image presented across the multiple displays regardless of the alignment of the devices with respect to each other.

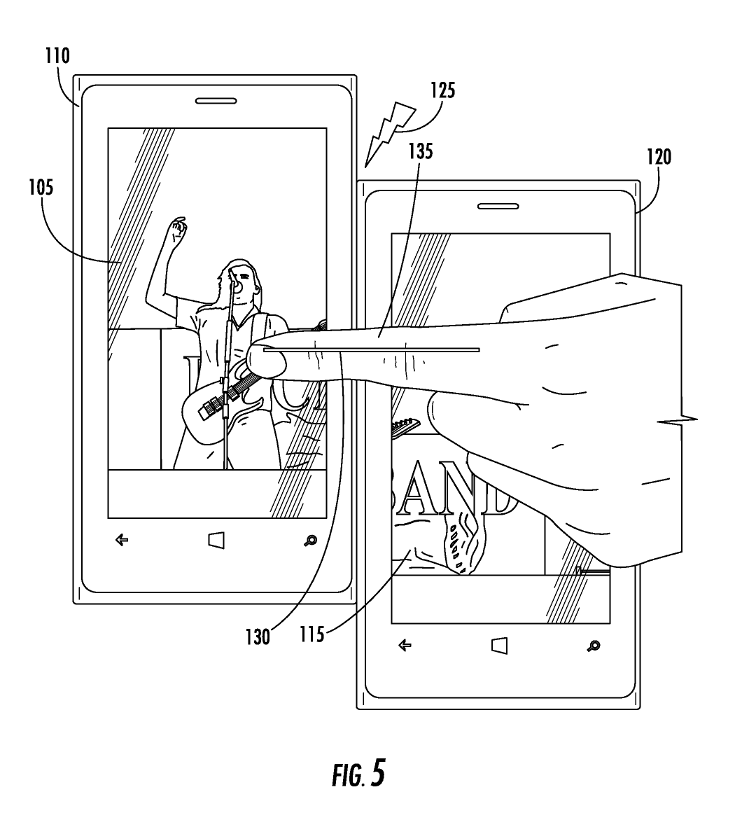

In this regard, the apparatus 100 may comprise at least one processor 70 and at least one memory 76 including computer program code, as shown in FIG. 4. With reference to FIGS. 4 and 5, the at least one memory 76 and the computer program code may be configured to, with the processor 70, cause the apparatus 100 to at least receive an indication that at least a first display 105 of a first user device 110 and a second display 115 of a second user device 120 are to cooperatively present an image. The first and second user devices 110, 120 may, in some embodiments, be user devices such as the user device 50 shown in FIG. 3 (for example, a smartphone). The indication may be, for example, the result of the first and second user devices 110, 120 being brought together and “tapped” (represented by the lightning bolt 125).

The at least one memory 76 and the computer program code may be further configured to, with the processor 70, cause the apparatus 100 to receive an indication of a user input, where the user input is a single user input that is applied to each of the first user device 110 and the second user device 120 substantially simultaneously (e.g., as a result of the same input gesture) and comprises a linear component 130 spanning the first and second displays 105, 115. For example, the single user input may comprise a hovering gesture provided above both the first and second displays 105, 115, such as the extension of one of the users' index finger 135 across the displays, as shown. In this example, the linear component 130, represented by the line approximating the user's finger 135 is registered both by the first display 105 and by the second display 115. The user may provide the hovering gesture by holding his or her finger over the two displays 105, 115 for longer than a predefined period of time, such as longer than 2 seconds.

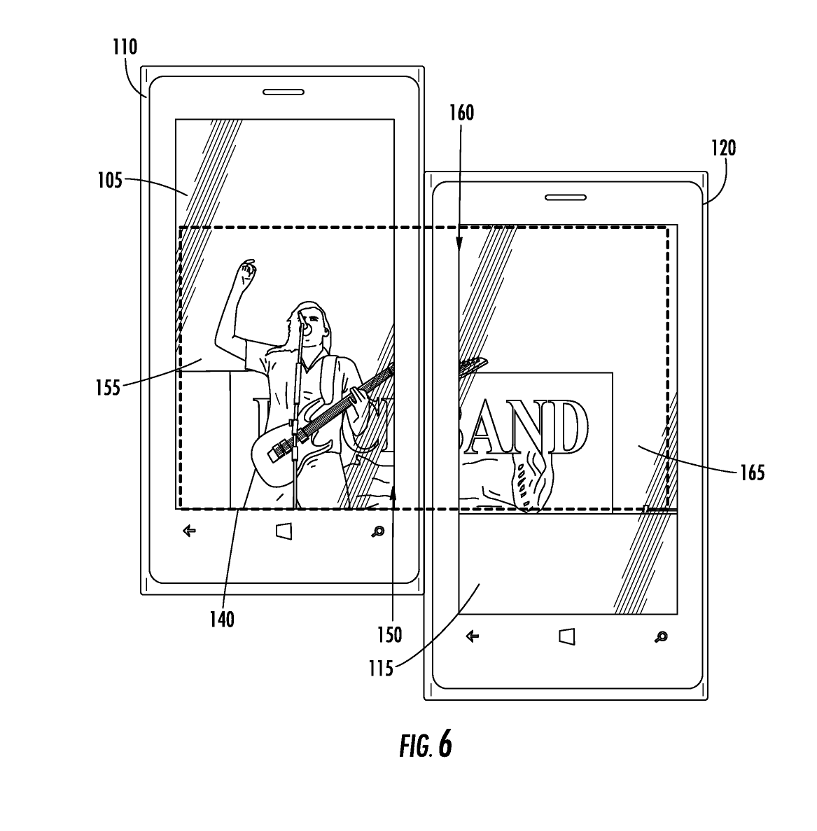

Based on a location of the linear component 130 with respect to the first display 105 and the location of the linear component with respect to the second display 115, the at least one memory 76 and the computer program code may be further configured to, with the processor 70, cause the apparatus 100 to determine a unitary viewing area 140 comprising a portion of the first display 105 and a portion of the second display 115, as shown in FIG. 6 using dashed lines. The at least one memory 76 and the computer program code may be configured to, with the processor 70, cause the apparatus 100 to cause the image to be presented in the unitary viewing area 140 such that an adjoining edge 150 of a first portion 155 of the image presented on the first display 105 is substantially aligned with an adjoining edge 160 of a second portion 165 of the image presented on the second display 115. In this way, the first and second portions 155, 165 of the image may be continuous across the first and second displays 105, 115, as depicted in FIG. 6 (e.g., the first portion may be horizontally aligned with the second portion). As used herein, the term “substantially aligned” means that the image portions appear to be visually aligned to a user, regardless of any actual minor misalignments that may exist on a pixel level.

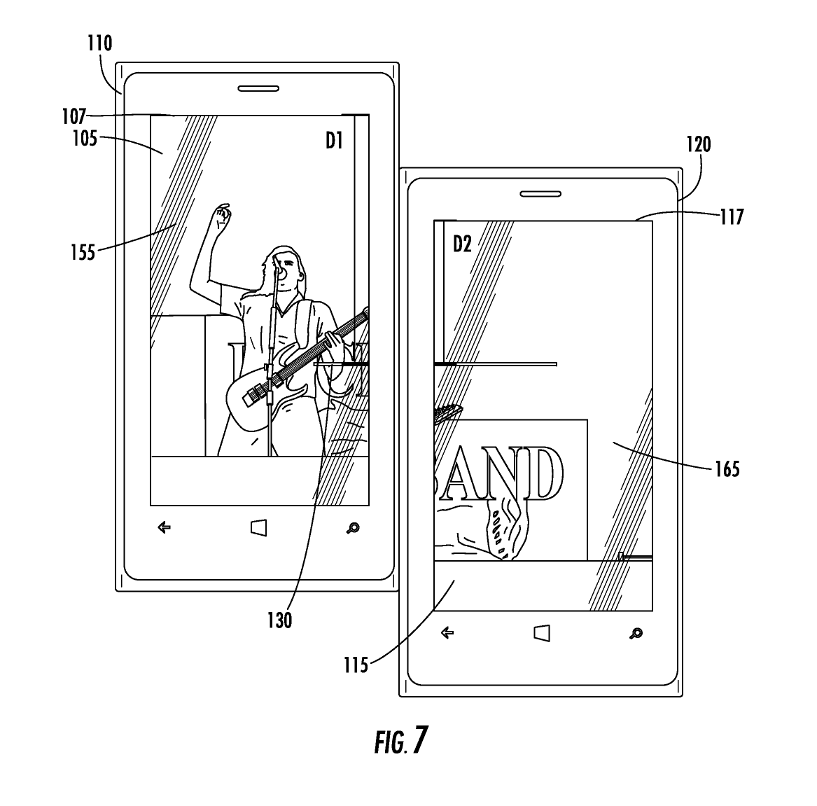

The unitary viewing area 140 may be determined across the first and second displays 105, 115 in various ways to provide for a continuous presentation of the first and second portions 155, 165 of the image. For example, in some embodiments, the at least one memory 76 and the computer program code may be configured to, with the processor 70, cause the apparatus 100 to determine the unitary viewing area 140 by calculating a first distance D1 between the linear component 130 and a first edge or a second edge (e.g., a top or bottom edge) of the first display 105, calculating a second distance D2 between the linear component and a corresponding first edge or second edge (e.g., top or bottom edge) of the second display 115, and calculating a difference between the first distance and the second distance, as shown in FIG. 7. In the depicted example, the distance D1 calculated with respect to the top edge 107 is greater than the distance D2 calculated with respect to the top edge 117 because the second user device 120 is shifted downward with respect to the first user device 110. As such, the difference between the distances D1-D2 represents the amount of misalignment between the two devices 110, 120.

Upon calculating the amount of misalignment D1-D2, the at least one memory 76 and the computer program code may be configured to, with the processor 70, cause the apparatus 100 to determine that the presentation of the first portion 155 should be shifted downward to by the amount of misalignment D1-D2. At the same time, the size of the first display 105 being known, the at least one memory and the computer program code may be configured to, with the processor, cause the apparatus to calculate an adjustment to the presentation of the image portions 155, 165 to take into account both the amount of misalignment D1-D2 of the two displays 105, 115 and the sizes of the displays (e.g., the available area on each device for presenting images).

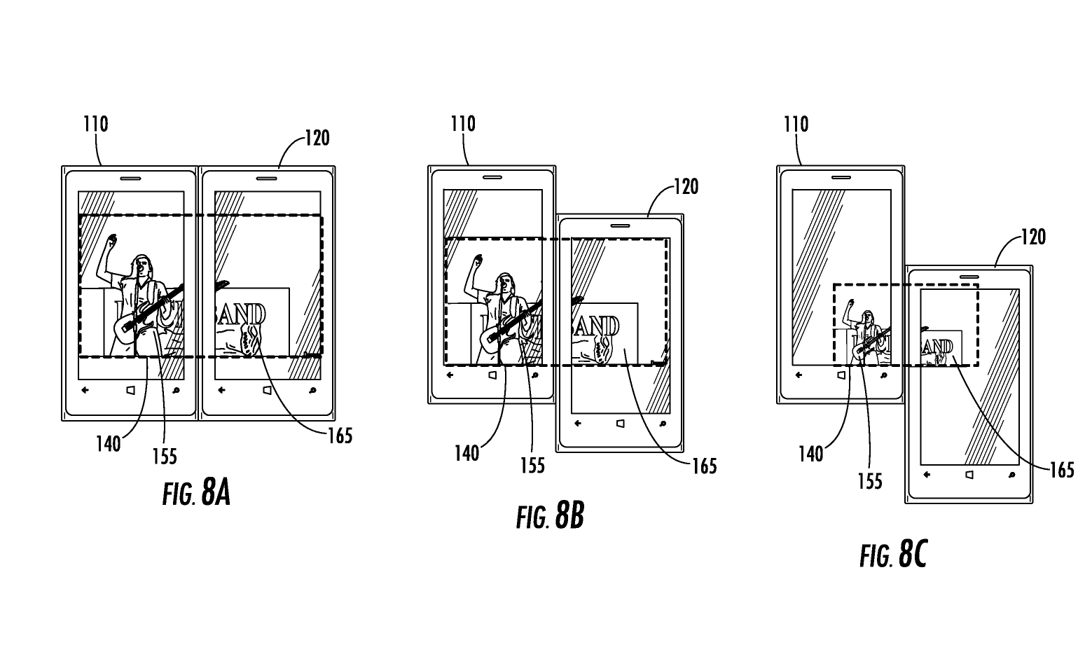

In some embodiments, for example, the at least one memory and the computer program code may be configured to, with the at least one processor, cause the apparatus to cause the image to be presented in the unitary viewing area 140 by scaling the image to fit within the unitary viewing area. In other words, due to the misalignment of the user devices 110, 120, the unitary viewing area 140 shown in FIG. 6 may have an area that is smaller than the total area that would otherwise be available if the full areas of each of the displays 105, 115 were added to each other. Thus, the image may be scaled to be smaller such that it fits within the smaller unitary viewing area 140, while maintaining substantially the same aspect ratio as the original image. FIGS. 8A, 8B, and 8C show examples of how the image may be scaled to fit unitary viewing areas 140 of different sizes corresponding to user devices 110, 120 that have varying degrees of misalignment.

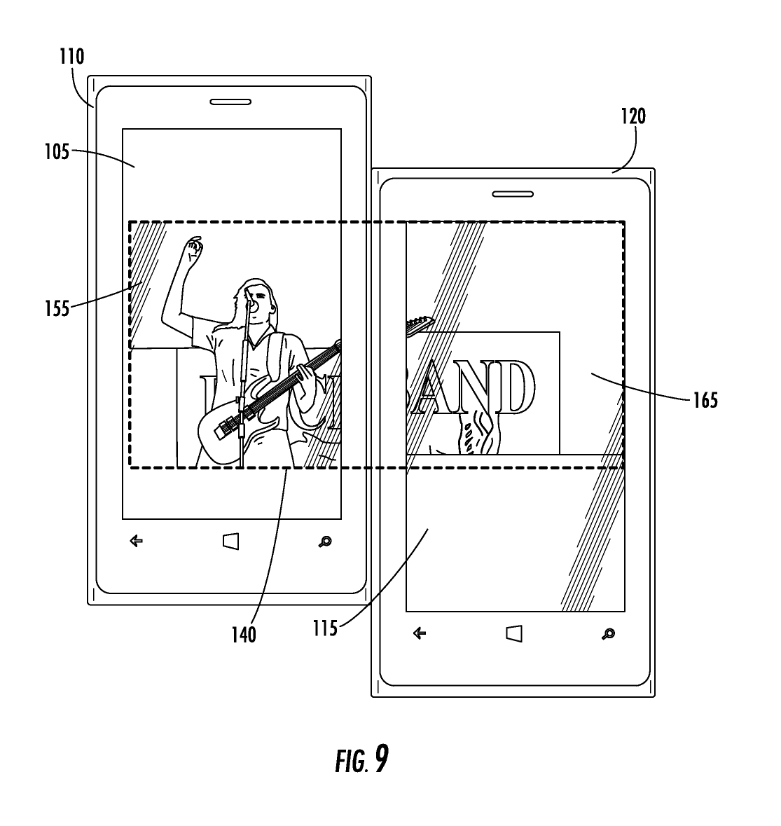

In other embodiments, the at least one memory and the computer program code may be further configured to, with the at least one processor, cause the apparatus to cause the image to be presented in the unitary viewing area 140 by causing a portion of the image corresponding to a size of the unitary viewing area to be presented in the unitary viewing area. An example of the presentation of a portion of the image that is cropped to fit within the unitary viewing area 140 is shown in FIG. 9.

In some cases, the at least one memory and the computer program code may be further configured to, with the at least one processor, cause the apparatus to receive an indication of a confirming input applied to one of the first or second displays 105, 115, wherein receipt of the indication of the confirming input triggers the determination of the unitary viewing area 140. With reference to FIG. 5, for example, after the single user input (e.g., the hovering gesture applied by the user's finger 135) has been applied for the predetermined amount of time, the first and second user devices 110, 120 may enter into an alignment mode. The linear component 130 of the single user input may, in some cases, be represented on the displays 105, 115, such that the users may be able to determine whether an accurate alignment is being assessed or whether a new single user input should be provided (e.g., if the user's finger was not pointing in a horizontal direction). If the user agrees with the orientation of the linear component 130 of the single user input, the user may confirm the alignment by providing a confirming input. For example, the user may provide a touch input to the first display 105 of the first user device 110 by using the tip of his or her finger to tap the first display while continuing to provide the single user input (e.g., the hovering gesture). Receipt of the touch input in this case may trigger the determination of the unitary viewing area 140, as described above, based on the linear component 130 of the single user input detected at the time the touch input is received.

Turning again to FIGS. 8A, 8B, and 8C, in some embodiments, the at least one memory and the computer program code may be further configured to, with the at least one processor, cause the apparatus to detect a change in a vertical position of one of the first or second user devices 110, 120 and adjust a configuration of the unitary viewing area 140 in response to the change detected. For example, the user devices 110, 120 may include accelerometers, gyroscopes, and/or magnetometers that are configured to track the relative positions of the respective user devices. The information from the accelerometers, gyroscopes, and/or magnetometers may in turn be used to re-calculate the unitary viewing area 140 to account for increases or decreases in the amount of misalignment between the devices and to adjust the presentation of the first and second portions 155, 165 of the image accordingly. Thus, if the user devices 110, 120 are moved from the relative positions shown in FIG. 8A to the relative positions shown in FIG. 8B to the relative positions shown in FIG. 8C, the first and second portions 155, 165 of the image may also be modified to match the resized unitary viewing area 140 in each case.

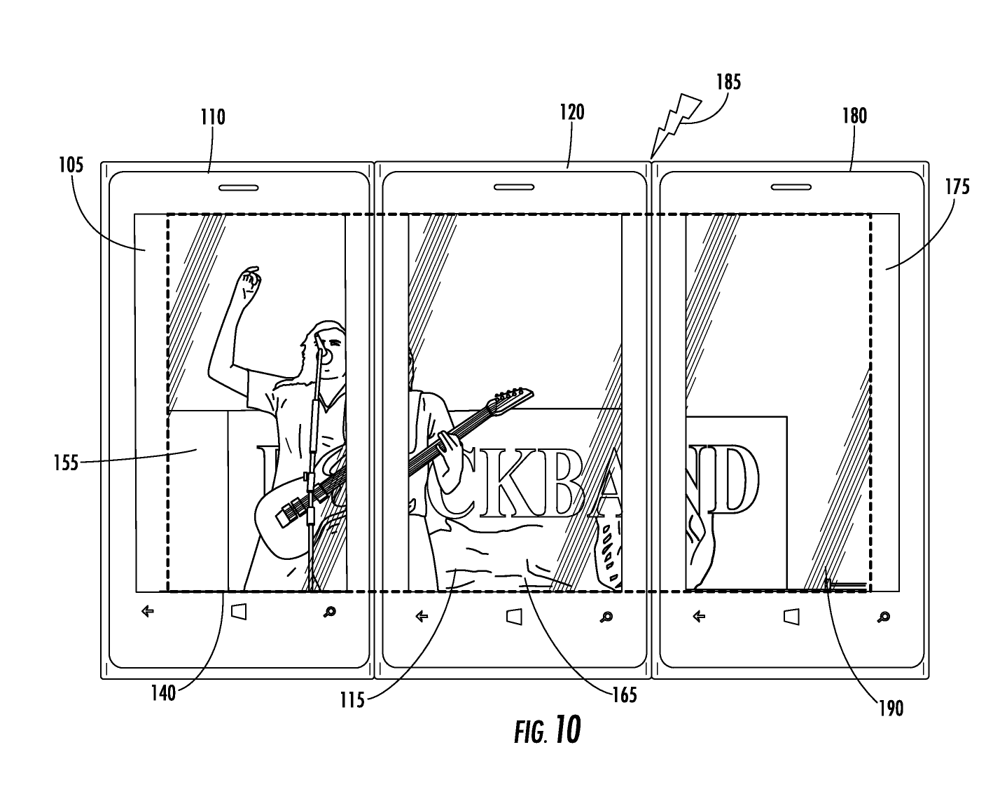

With reference now to FIG. 10, in still other embodiments, the at least one memory and the computer program code may further be configured to, with the at least one processor, cause the apparatus to receive an indication that at least a third display 175 of a third user device 180 is to cooperatively present the image with the first display 105 and the second display 115. The third user device 180 may, in some cases, be a user device such as the user device 50 shown in FIG. 3 (e.g., a smartphone). For example, a third user may wish to share in the viewing experience of the first and second users using his own user device 180 and may “tap” his device to the second user device 120 (represented by the lightning bolt 185), thus resulting in the image being broken up into three aligned image portions 155, 165, 190 that are presented across the three displays 105, 115, 175, as shown and described above with respect to embodiments including two user devices.

In embodiments in which an indication is received that at least a third display of a third user device is to cooperatively present the image with the first display and the second display, as described above, the at least one memory and the computer program code may be further configured to, with the at least one processor, cause the apparatus to designate one of the first, second, or third user devices 110, 120, 180 as a master device and cause the portion of the image presented (e.g., the “cropped” portion of the whole image that is selected for presentation within the unitary viewing area 140) to be shifted within the unitary viewing area based on a detected change in a location of the master device with respect to the other devices.

With continued reference to FIG. 10, in a case in which one of the devices 110, 120, 180 is removed from the configuration that is cooperating to present the image across the three displays via the unitary viewing area 140, depending upon which of the devices is removed, the remaining devices may cooperate to present the image across the remaining two displays via a modified unitary viewing area or may each present the entire image across the display of each. For example, in the event one of the user devices 110, 180 on either end of the configuration is removed (e.g., the right-most user device 180), the unitary viewing area 140 in some embodiments may be re-calculated as described above such that it is provided across the remaining two displays (similar to what is shown in FIG. 8A, for example). In the event a user device that is not on either end of the configuration is removed (e.g., the middle user device 120 in FIG. 10), each of the remaining user devices 110, 180 will revert to showing the image in its entirety on the respective display, and the remaining devices will cease to cooperate to provide the image via the unitary viewing area 140 as the unitary viewing area is no longer continuous (e.g., there would be a gap between the two remaining device 110, 180 left by the removal of the middle device 120).

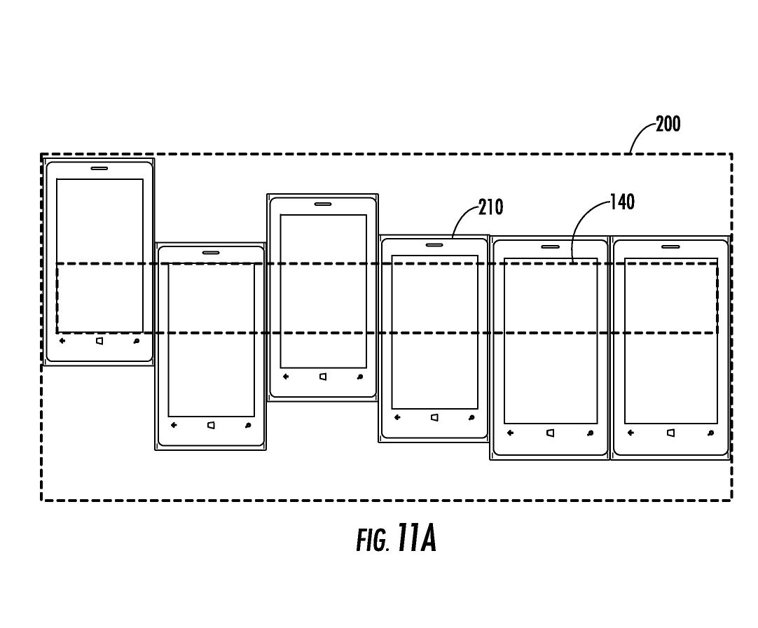

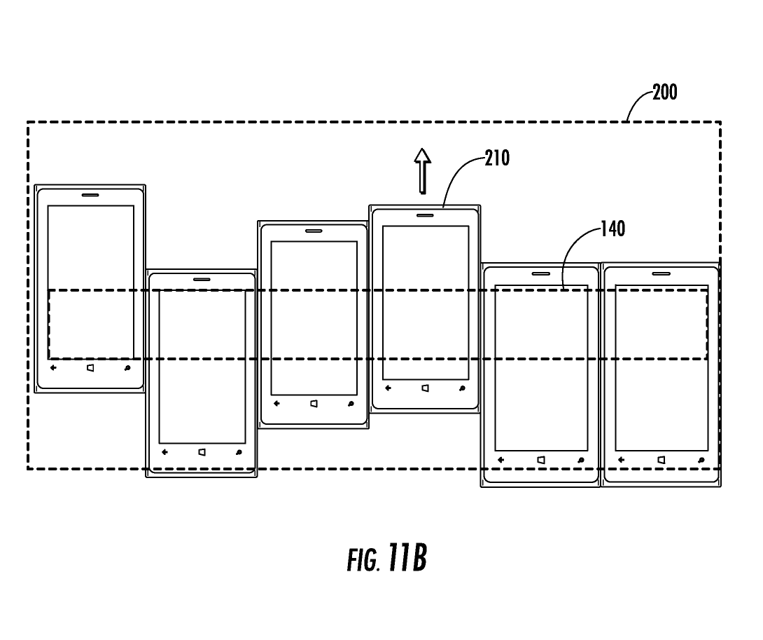

In FIG. 11A, for example, an embodiment is depicted in which six user devices are cooperating to present a portion (within the unitary viewing area 140) of a larger image (represented by a rectangle 200) across the six displays. The portion may be determined based on the size of the unitary viewing area 140. For example, in a case where the image cannot be scaled to fit the unitary viewing area 140 with the correct aspect ratio, an unscaled portion of the whole image 200 may be displayed instead. In this example, a master device 210 may be designated, such as in response to the receipt of user input (e.g., a touch input or a selection of an option presented upon one or more of the displays), and movement of the master device may in turn adjust the portion being displayed (e.g., with the perceived effect of scrolling up or down within the larger image 200). Thus, movement of the master device 210 upward, relative to the other devices, may result in a shift downward of the portion being displayed in the unitary viewing area 140, e.g., as though the entire image 200 is being moved upward with the master device while the unitary viewing area is being held in place, as shown in FIG. 11B.

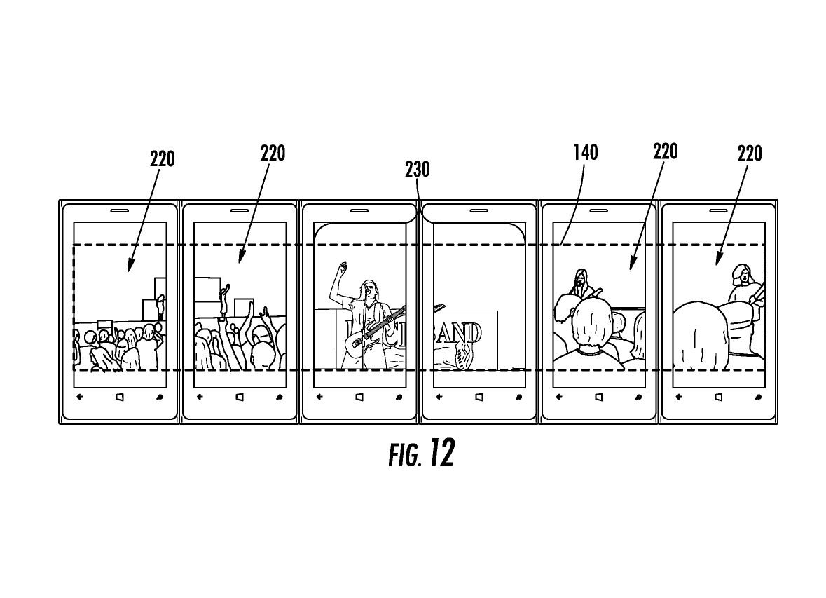

In some embodiments, the image presented in the unitary viewing area may be smaller than the unitary viewing area that is determined. In such cases, the at least one memory and the computer program code may be further configured to, with the at least one processor, cause the apparatus to present at least one additional image with the image presented within the unitary display. In FIG. 12, for example, six user devices are shown that are cooperating to present an image or images within a unitary viewing area 140 determined as described above. Because, in this example, the size of the unitary viewing area 140 is larger than the largest size of the image that can reasonably be presented within the unitary viewing area 140 (e.g., without distorting the image or otherwise detracting from the viewing experience), the apparatus may be configured, via the processor, to pull additional images 220 from the same source as the original image 230 to be presented across the displays (e.g., from the same user's photo gallery from which the original image is being accessed) and to present the additional images alongside the original image.

In this way, portions of the unitary viewing area 140 that may have otherwise been left blank are filled with images that relate to the image that the users originally intended to view, thereby creating a more complete and satisfying viewing experience for the users while still making use of the full extent of the unitary viewing area determined. Although in FIG. 12 the user devices are shown as being generally aligned, misalignments between the multiple user devices may be detected, a unitary viewing area 140 may be determined across the multiple devices, and adjustments may be made to the presentation of the image in the unitary viewing area as described above.

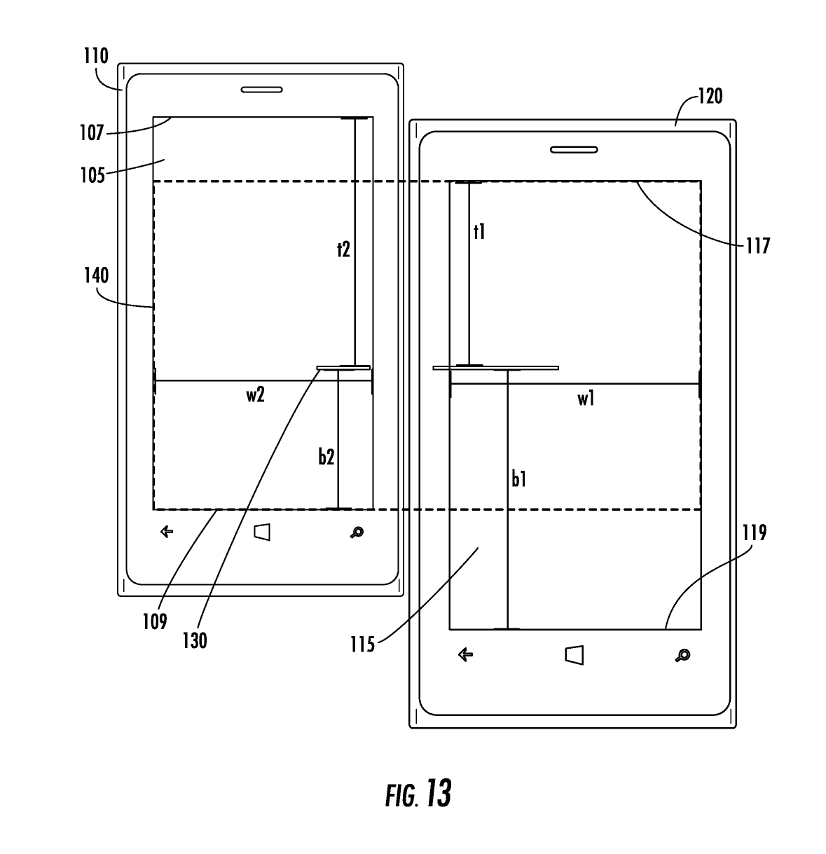

The user devices depicted in the figures with respect to the embodiments described above are shown as being the same types of devices having relatively displays that are relatively the same size. In some embodiments, however, the different user devices may have displays of different sizes. With reference to FIG. 13, the first device 110 may, for example, be smaller than the second device 120, and the display 105 of the first device may be smaller than the display 115 of the second device. In this case, each device 110, 120 may calculate a distance t1, t2 from the top edge 107, 117 of the each display 105, 115 to the linear component 130 and a distance b1, b2 from the bottom edge 109, 119 of each display 105, 115 to the linear component.

Furthermore, the user devices 110, 120 may determine the respective widths w1, w2 of each display 105, 115 (e.g., the user device(s) may have data on the width of their respect displays stored in a memory of the device and/or may receive data from the other user device regarding its own display width). Using this information, the at least one memory and the computer program code may be configured to, with the processor, cause the apparatus to determine the unitary viewing area 140 by calculating the height of the unitary viewing area as being the minimum of the dimensions t1, t2 plus the minimum of the dimensions b1, b2, such that the height of the unitary viewing area 140 does not extend past the available display area of either of the displays 105, 115. The width of the unitary viewing area 140 may be calculated as the sum of the widths w1, w2 of the two displays 105, 115. Thus, in equation form, the height and width of the unitary viewing area 140 may be calculated as follows:

Height=min(t1,t2)+min(b1,b2)

Width=w1+w2

In the depicted example of FIG. 13, for instance, the height of the unitary viewing area 140 would be equal to t1+b2, and the width of the unitary viewing area would be equal to w1+w2, as depicted.

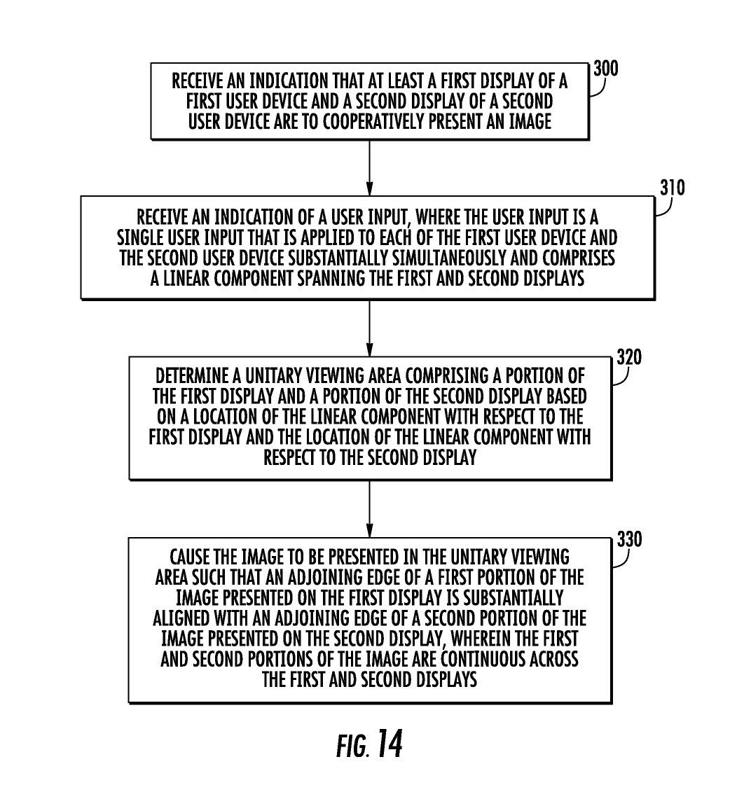

FIG. 14 illustrates a flowchart of systems, methods, and computer program products according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an example embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions, and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, one example embodiment of a method for determining a unitary viewing area across multiple displays is shown in FIG. 14. FIG. 14 depicts an example embodiment of the method that includes receiving an indication that at least a first display of a first user device and a second display of a second user device are to cooperatively present an image at block 300 and receiving an indication of a user input at block 310, where the user input is a single user input that is applied to each of the first user device and the second user device substantially simultaneously and comprises a linear component spanning the first and second displays. According to the method, a unitary viewing area may be determined at block 320, where the unitary viewing area comprises a portion of the first display and a portion of the second display based on a location of the linear component with respect to the first display and the location of the linear component with respect to the second display. Presentation of the image in the unitary viewing area may be caused at block 330, such that an adjoining edge of a first portion of the image presented on the first display is substantially aligned with an adjoining edge of a second portion of the image presented on the second display. In this way, the first and second portions of the image may be continuous across the first and second displays.

In some cases, the single user input may comprise a hovering gesture that is provided above both the first and second displays. Moreover, an indication of a confirming input applied to one of the first or second displays, such as a touch input, may be received, and receipt of the indication of the confirming input may trigger the determination of the unitary viewing area. In some embodiments, a change in the vertical position of one of the first or second user devices may be detected, and a configuration of the unitary viewing area may be adjusted in response to the change detected, as described above.

The unitary viewing area may, in some cases, be determined by calculating a first distance between the linear component and a top or bottom edge of the first display, calculating a second distance between the linear component and a corresponding top or bottom edge of the second display, and calculating a difference between the first distance and the second distance. In this way, as described above, the misalignment between the first display and the second display may be calculated, and the configuration of the unitary viewing area may be determined to accommodate the misalignment.

In some embodiments, the image to be presented in the unitary viewing area may be scaled to fit within the unitary viewing area. In other embodiments, the image to be presented in the unitary viewing area may be cropped to a portion of the whole image that corresponds to a size of the unitary viewing area. Additionally or alternatively, an indication that at least a third display of a third user device is to cooperatively present the image with the first display and the second display may be received. In some such cases, one of the first, second, or third user devices may be designated as a master device, and a portion of the image corresponding to a size of the unitary viewing area that is presented in the unitary viewing area maybe be shifted within the unitary viewing area based on a detected change in a location of the master device with respect to the other devices, as described above.

In some embodiments, certain ones of the operations above may be modified or further amplified as described below. Furthermore, in some embodiments, additional optional operations may be included. Although the operations above are shown in a certain order in FIG. 14, certain operations may be performed in any order. In addition, modifications, additions, or amplifications to the operations above may be performed in any order and in any combination.

In an example embodiment, an apparatus for performing the methods of FIG. 14 above may comprise a processor (e.g., the processor 70 of FIG. 4) configured to perform some or each of the operations (300-330) described above. The processor may, for example, be configured to perform the operations (300-330) by performing hardware implemented logical functions, executing stored instructions, or executing algorithms for performing each of the operations.

Alternatively, the apparatus may comprise means for performing each of the operations described above. In this regard, according to an example embodiment, examples of means for performing operations 300 and 310 may comprise, for example, the processor 70, the user interface transceiver 72, and/or a device or circuit for executing instructions or executing an algorithm for processing information as described above. Examples of means for performing operations 320 and 330 may comprise, for example, the memory device 76, the processor 70, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. In this regard, for example, different combinations of elements and/or functions than those explicitly described above are also contemplated as may be set forth in some of the appended claims.

Furthermore, although the description above refers to “horizontal” and/or “vertical” alignments, orientations, configurations, etc., it is understood that embodiments of the invention are applicable for aligning images in any orientation. In this regard, the mechanisms described herein are configured to determine a relative alignment of images that extend in a particular direction (such as, but not limited to, a horizontal alignment) between two or more mobile device displays and to determine an optimal presentation of an image across the multiple displays.

Moreover, although in the examples provided above the unitary viewing area is presented in a landscape orientation (e.g., where the horizontal dimension is longer than the vertical dimension), in some embodiments the unitary viewing area may be presented in a portrait orientation (e.g., where the vertical dimension is longer than the horizontal dimension), such as when the user devices are arranged one on top of the next.

Although specific terms are employed herein, they are used in a generic and descriptive sense only and not for purposes of limitation.

What is claimed is:

1. An apparatus comprising:
at least one a processor; and
at least one memory including computer program code, the at least one memory and the computer program code configured to, with the at least one processor, cause the apparatus at least to:
receive an indication that at least a first display of a first user device and a second display of a second user device are to cooperatively present an image;
receive an indication of a user input, where the user input is a single user input that is applied to each of the first user device and the second user device substantially simultaneously and comprises a linear component spanning the first and second displays;
determine a unitary viewing area comprising a portion of the first display and a portion of the second display based on a location of the linear component with respect to the first display and the location of the linear component with respect to the second display; and
cause the image to be presented in the unitary viewing area such that an adjoining edge of a first portion of the image presented on the first display is substantially aligned with an adjoining edge of a second portion of the image presented on the second display, wherein the first and second portions of the image are continuous across the first and second displays.

2. The apparatus according to claim 1, wherein the at least one memory and the computer program code are further configured to, with the at least one processor, cause the apparatus to detect a change in a vertical position of one of the first or second user devices and adjust a configuration of the unitary viewing area in response to the change detected.

3. The apparatus according to claim 1, wherein the single user input comprises a hovering gesture provided above both the first and second displays.

4. The apparatus according to claim 1, wherein the at least one memory and the computer program code are further configured to, with the at least one processor, cause the apparatus to receive an indication of a confirming input applied to one of the first or second displays, wherein receipt of the indication of the confirming input triggers the determination of the unitary viewing area.

5. The apparatus according to claim 1, wherein the at least one memory and the computer program code are further configured to, with the at least one processor, cause the apparatus to determine the unitary viewing area by calculating a first distance between the linear component and a top or bottom edge of the first display, calculating a second distance between the linear component and a corresponding top or bottom edge of the second display, and calculating a difference between the first distance and the second distance.

6. The apparatus according to claim 1, wherein the at least one memory and the computer program code are further configured to, with the at least one processor, cause the apparatus to receive an indication that at least a third display of a third user device is to cooperatively present the image with the first display and the second display.

7. The apparatus according to claim 1, wherein the at least one memory and the computer program code are further configured to, with the at least one processor, cause the apparatus to cause the image to be presented in the unitary viewing area by scaling the image to fit within the unitary viewing area.

8. The apparatus according to claim 1, wherein the at least one memory and the computer program code are further configured to, with the at least one processor, cause the apparatus to cause the image to be presented in the unitary viewing area by causing a portion of the image corresponding to a size of the unitary viewing area to be presented in the unitary viewing area.

9. The apparatus according to claim 8, wherein the at least one memory and the computer program code are further configured to, with the at least one processor, cause the apparatus to:
receive an indication that at least a third display of a third user device is to cooperatively present the image with the first display and the second display;
designate one of the first, second, or third user devices as a master device; and
cause the portion of the image presented to be shifted within the unitary viewing area based on a detected change in a location of the master device with respect to the other devices.

10. The apparatus according to claim 1, wherein the image presented in the unitary viewing area is smaller than the unitary viewing area, wherein the at least one memory and the computer program code are further configured to, with the at least one processor, cause the apparatus to present at least one additional image with the image presented within the unitary display.

11. A method comprising:
receiving an indication that at least a first display of a first user device and a second display of a second user device are to cooperatively present an image;
receiving an indication of a user input, where the user input is a single user input that is applied to each of the first user device and the second user device substantially simultaneously and comprises a linear component spanning the first and second displays;
determining, via a processor, a unitary viewing area comprising a portion of the first display and a portion of the second display based on a location of the linear component with respect to the first display and the location of the linear component with respect to the second display; and
causing the image to be presented in the unitary viewing area such that an adjoining edge of a first portion of the image presented on the first display is substantially aligned with an adjoining edge of a second portion of the image presented on the second display, wherein the first and second portions of the image are continuous across the first and second displays.

12. The method of claim 11 further comprising detecting a change in a vertical position of one of the first or second user devices and adjusting a configuration of the unitary viewing area in response to the change detected.

13. The method of claim 11 further comprising receiving an indication of a confirming input applied to one of the first or second displays, wherein receipt of the indication of the confirming input triggers the determination of the unitary viewing area.

14. The method of claim 11, wherein causing the image to be presented in the unitary viewing area comprises causing a portion of the image corresponding to a size of the unitary viewing area to be presented in the unitary viewing area, the method further comprising:
receiving an indication that at least a third display of a third user device is to cooperatively present the image with the first display and the second display;
designating one of the first, second, or third user devices as a master device; and
causing the portion of the image presented to be shifted within the unitary viewing area based on a detected change in a location of the master device with respect to the other devices.

15. A computer program product comprising at least one non-transitory computer-readable storage medium having computer-executable program code portions stored therein, the computer-executable program code portions comprising program code instructions for:
receiving an indication that at least a first display of a first user device and a second display of a second user device are to cooperatively present an image;
receiving an indication of a user input, where the user input is a single user input that is applied to each of the first user device and the second user device substantially simultaneously and comprises a linear component spanning the first and second displays;
determining a unitary viewing area comprising a portion of the first display and a portion of the second display based on a location of the linear component with respect to the first display and the location of the linear component with respect to the second display; and
causing the image to be presented in the unitary viewing area such that an adjoining edge of a first portion of the image presented on the first display is substantially aligned with an adjoining edge of a second portion of the image presented on the second display, wherein the first and second portions of the image are continuous across the first and second displays.

16. A computer program product according to claim 15 wherein the computer-executable program code portions further comprise program code instructions for detecting a change in a vertical position of one of the first or second user devices and adjusting a configuration of the unitary viewing area in response to the change detected.

17. A computer program product according to claim 15 wherein the computer-executable program code portions further comprise program code instructions for receiving an indication of a confirming input applied to one of the first or second displays, wherein receipt of the indication of the confirming input triggers the determination of the unitary viewing area.

18. A computer program product according to claim 15 wherein the computer-executable program code portions further comprise program code instructions for receiving an indication that at least a third display of a third user device is to cooperatively present the image with the first display and the second display.

19. A computer program product according to claim 15 wherein the computer-executable program code portions for causing the image to be presented in the unitary viewing area further comprise program code instructions for causing a portion of the image corresponding to a size of the unitary viewing area to be presented in the unitary viewing area.

20. A computer program product according to claim 19 wherein the computer-executable program code portions further comprise program code instructions for:
receiving an indication that at least a third display of a third user device is to cooperatively present the image with the first display and the second display;
designating one of the first, second, or third user devices as a master device; and
causing the portion of the image presented to be shifted within the unitary viewing area based on a detected change in a location of the master device with respect to the other devices.
